(19) United States
(12) Patent Application Publication
(10) Pub. No.: US 2005/0180334 A1
(43) Pub. Date: Aug. 18, 2005

(54) Monitoring path changing method and transmission device using the same

(76) Inventors: Ryota Komatsu, Kawasaki (JP); Hideo Kuraya, Kawasaki (JP)

Correspondence Address: KATTEN MUCHIN ROSENMAN LLP, 575 MADISON AVENUE, NEW YORK, NY, 10022-2585, US

(21) Appl. No.: 11/087,126

(22) Filed: Mar. 23, 2005

Related U.S. Application Data
(63) Continuation of application No. PCT/JP02/12927, filed on Dec. 10, 2002.

(51) Int. Cl. H04L 12/26

(52) U.S. Cl. 370/248; 370/251

(57) ABSTRACT

A monitoring path changing method is disclosed that changes monitoring paths by sending and receiving monitoring path control information in a system having a monitoring control terminal to control and monitor plural transmission devices with use of the monitoring paths. Each of the monitoring paths corresponds to an area within a transmission channel data frame. The monitoring path control information controls the monitoring paths. The monitoring control terminal is connected to one of the transmission devices. The transmission devices are connected to each other via transmission channels so as to form a network. The method comprises steps of causing one of the transmission devices opposed by another of the transmission devices via one of the transmission channels to return monitoring path control information sent from the opposing transmission device, and causing the opposing transmission device to execute a monitoring path change when the opposing transmission device receives the monitoring path control information sent by itself.

### CROSS-REFERENCE TO RELATED APPLICATIONS

This application is a U.S. continuation application filed under 35 USC 111(a) claiming benefit under 35 USC 120 and 365(c) of PCT application JP2002/012927, filed on Dec. 10, 2002, the entire contents of which are incorporated herein by reference.

### BACKGROUND OF THE INVENTION

1. Field of the Invention

The present invention relates to a monitoring path changing method and a transmission device using the same, and particularly relates to a monitoring path changing method that changes monitoring paths of a network monitoring system and a transmission device using the same.

2. Description of the Related Art

There are some systems that have a configuration shown in FIG. 1, in which a monitoring control terminal 10 monitors a network comprising plural transmission devices A through G connected via a transmission channel with the use of a communication path for monitoring control constructed in the network.

In SONET (Synchronous Optical Network) used mainly in North America and SDH (Synchronous Digital Hierarchy) used in other countries, a monitoring path control frame is usually allocated to a SOH (Section Overhead) or an available area in a payload of a normal transmission channel frame.

In the case where the network configuration or a line is changed, it is necessary to move the monitoring path control frame from the SOH to the payload, or change the allocated area within the payload without affecting areas used by a user.

If there is a multiplexing device between the transmission devices, only the payload is multiplexed and the monitoring path control frame allocated to the SOH remains without being multiplexed. Therefore, the monitoring path control frame should be moved to the payload.

A method illustrated in FIG. 2 is known as a method for changing a monitoring path, in which the monitoring control terminal 10 broadcasts monitoring path change instructions to all the transmission devices A through G in the network. FIG. 3 shows another known method, in which operators manually change the monitoring path of the respective devices A through G using front control panels thereof.

However, if the method of broadcasting monitoring path change instructions to the transmission devices A through G is used in a large network, it is difficult to synchronize the monitoring path changes of all the transmission devices because of transmission delays and differences in the monitoring processing time. If the timing of the monitoring path change differs device to device, the monitoring path change instruction cannot reach a device located at a distal end of the network. This results in differences in the allocation area of the monitoring path control frame, so that the monitoring cannot be performed.

On the other hand, in the case where operators manually change the monitoring path of the respective transmission devices, there might occur execution time differences of the path changes among the transmission devices as well as a data loss or incorrect data input due to operational mistakes.

Relating to the above methods, Japanese Laid Open Publication No. 63-211835 discloses a network monitoring path setting/control system. Also, Japanese Laid Open Publication No. 1-128640 discloses a network path switching method in the event of a failure, and Japanese Laid Open Publication No. 5-110545 discloses a device capable of correctly switching path routes in the event of a failure.

### SUMMARY OF THE INVENTION

A general object of the present invention is to provide a monitoring path changing method and a transmission device using the same to solve at least one problem described above. A specific object of the present invention is to provide a monitoring path changing method and a transmission device using the same capable of quickly changing monitoring paths without losing important failure and control information.

To achieve these and other object of the present invention, there is provided a monitoring path changing method for changing monitoring paths by sending and receiving monitoring path control information in a system having a monitoring control terminal to control and monitor plural transmission devices with use of the monitoring paths, each of the monitoring paths corresponding to an area within a transmission channel data frame, the monitoring path control information controlling the monitoring paths, the monitoring control terminal being connected to one of the transmission devices, the transmission devices being connected to each other via transmission channels so as to form a network, the method comprising steps of causing one of the transmission devices opposed by another of the transmission devices via one of the transmission channels to return monitoring path control information sent from the opposing transmission device, and causing the opposing transmission device to execute a monitoring path change when the opposing transmission device receives the monitoring path control information sent by itself.

This monitoring path changing method makes it possible to synchronize monitoring path changes among the transmission devices and to quickly change monitoring paths without losing important failure and control information.

### BRIEF DESCRIPTION OF THE DRAWINGS

The preferred embodiments of the present invention are described in detail below with reference to the following drawings.

FIG. 1 is a block diagram showing the configuration of a network;

FIG. 2 is a diagram illustrating a related-art monitoring path changing method;

FIG. 3 is a diagram illustrating another related-art monitoring path changing method;

FIG. 4 is a functional block diagram of an embodiment of a transmission device of the present invention;

FIG. 5 is a block diagram showing a first embodiment of a network system;

FIG. 6 is a diagram showing the structure of a transmission channel data frame;

FIG. 7 is a sequence diagram for a first embodiment of a method of the present invention;

FIG. 8 is a sequence diagram for a second embodiment of the method of the present invention;

FIG. 9 is a block diagram showing a second embodiment of the network system;

FIG. 10 is a sequence diagram for a third embodiment of the method of the present invention; and

FIG. 11 is a sequence diagram for a fourth embodiment of the method of the present invention.

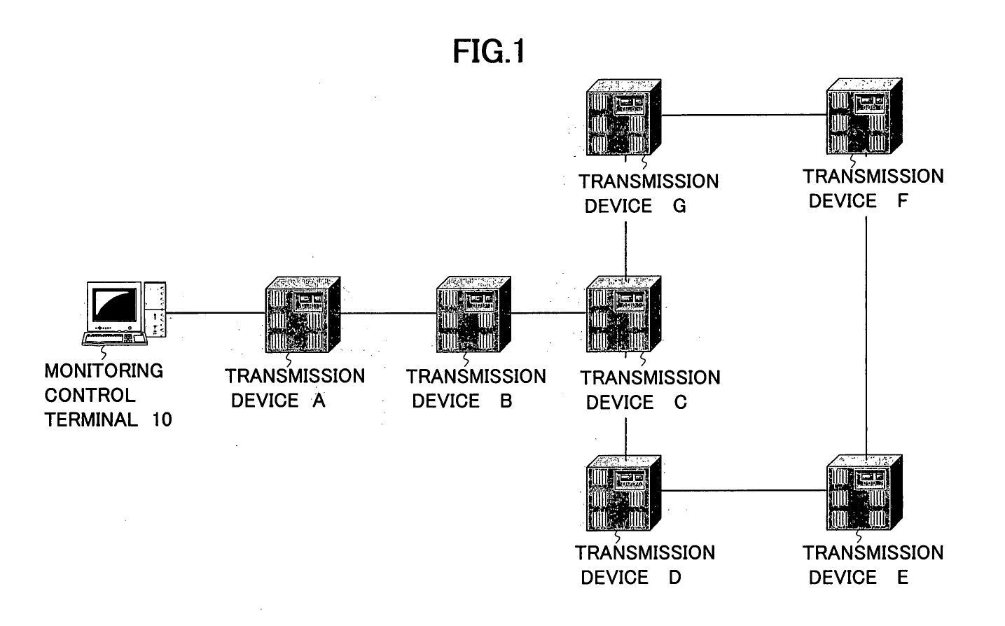

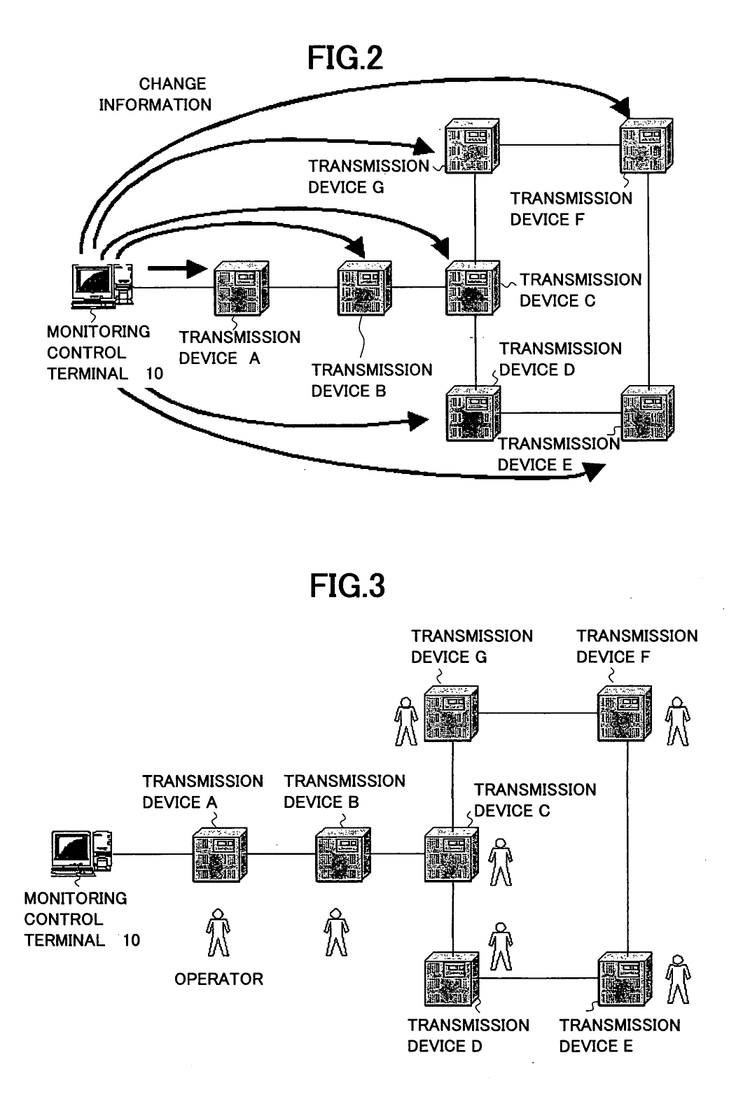

### DETAILED DESCRIPTION OF THE PREFERRED EMBODIMENT

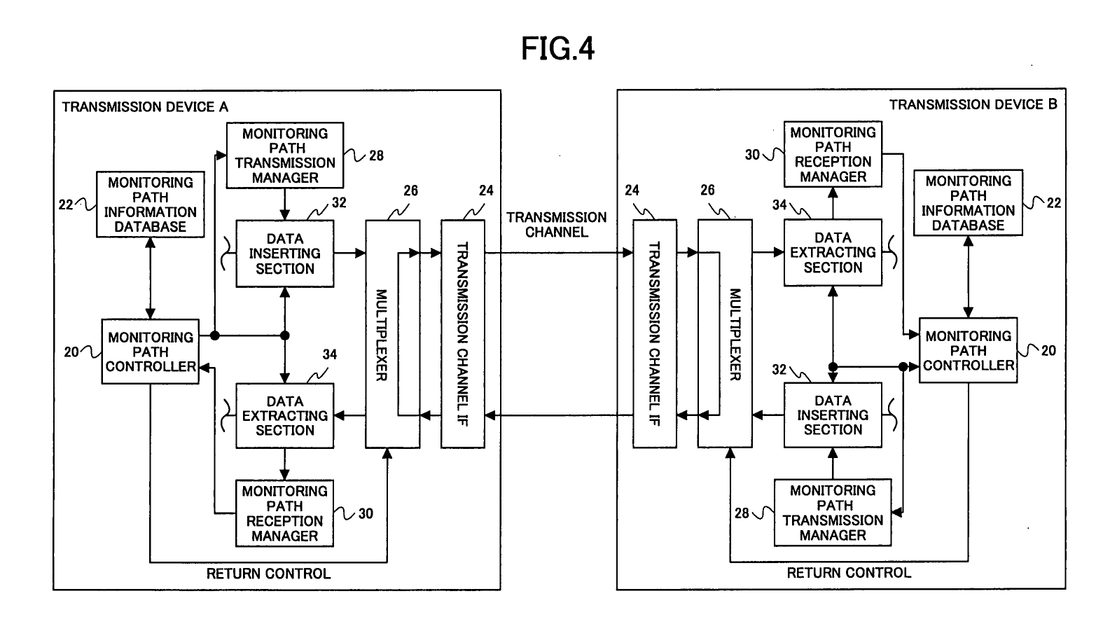

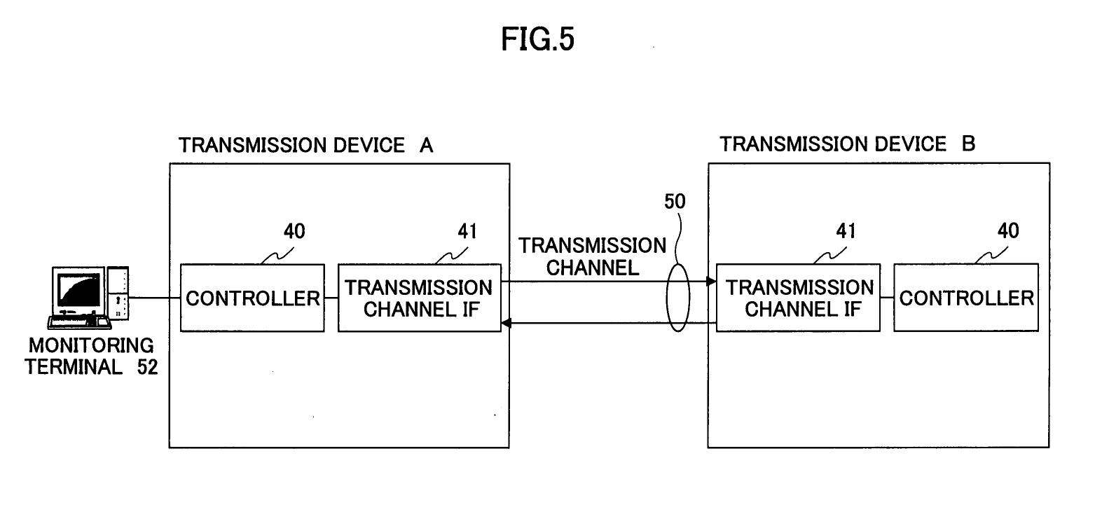

Referring to FIG. 4, there is shown a functional block diagram of an embodiment of a transmission device of the present invention. In order to simplify the explanation, FIG. 4 illustrates two transmission devices A and B interconnected via a transmission channel and having the same functional configuration. In FIG. 4, a monitoring path controller 20 controls the transmission/reception of monitoring path control information (i.e., monitoring path control frame), and determines whether to execute a return control based on received monitoring path control information. A monitoring path information database 22 stores the monitoring path control information. A transmission channel IF (interface) 24 is a point connected to the transmission channel.

A multiplexer 26 executes data multiplexing and the return control. A monitoring path transmission manager 28 manages the transmission of the monitoring path control information according to an instruction from the monitoring path controller 20. A monitoring path reception manager 30 manages the reception of the monitoring path control information according to an instruction from the monitoring path controller 20. A data inserting section 32 inserts the monitoring path control information from the monitoring path transmission manager 28 into an area of an outgoing transmission channel data frame specified by the monitoring path controller 20. A data extracting section 34 extracts the monitoring path control information from the area of the transmission channel data frame, which is received according to an instruction of the monitoring path controller 20, specified by the monitoring path controller 20 and sends the information to the monitoring path controller 20.

In the transmission device A, the monitoring path controller 20 adds a sender address, i.e., the address of the transmission device A, to the monitoring path control information acquired from the monitoring path information database 22 and sends the information to the monitoring path transmission manager 28. The monitoring path transmission manager 28 sends the monitoring path control information to the data inserting section 32 to insert the information into the transmission channel data frame. The inserted monitoring path control information is transmitted to the transmission device B via the multiplexer 26 and the transmission channel IF 24.

In the transmission device B, the data extracting section 34 extracts the monitoring path control information from the received transmission channel data frame. The monitoring path control information is relayed by the monitoring path reception manager 30 to be sent to the monitoring path controller 20. The monitoring path controller 20 adds a sender address, i.e., the address of the transmission device B, to the received monitoring path control information and sends back the information.

During normal operations, the transmission/reception of the monitoring path information is executed on a regular basis. For executing the monitoring path change with the initiative of the transmission device A, the monitoring path controller 20 of the transmission device A changes a monitoring path of thereof to trigger the monitoring path change while having the multiplexer 26 execute a return control.

With the return control, the monitoring path control information transmitted from the transmission device B is sent back to the transmission device B by the multiplexer 26 of the transmission device A. When the monitoring path controller 20 of the transmission device B refers to the sender address of the monitoring path control information and recognizes that the sender address is its own address (the address of the device B), the monitoring path controller 20 of the transmission device B changes a monitoring path thereof. The monitoring path change is thus completed between the transmission devices A and B.

Referring to FIG. 5, there is shown a block diagram of a first embodiment of a network system. FIG. 5 illustrates two transmission devices A an B interconnected via a transmission channel as in FIG. 4. In FIG. 5, the transmission device A has a controller 40 (corresponding to the monitoring path controller 20) and a transmission channel IF 41 (corresponding to the transmission channel IF 24). The transmission device B also has a controller 40 and a transmission channel IF 41. The transmission channel IFs 41 of the transmission devices A and B are connected to each other by a transmission channel 50. The controller 40 of the transmission device A is connected to a monitoring terminal 52, which executes settings of the monitoring path change.

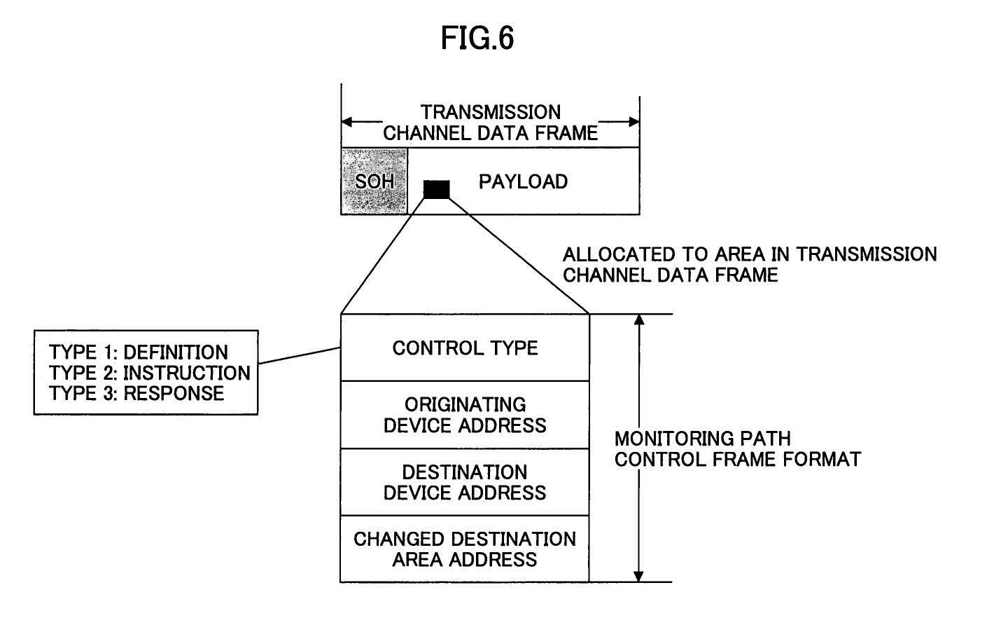

FIG. 6 is a diagram showing the structure of a transmission channel data frame. The transmission channel data frame comprises a SOH and a payload. An area of a monitoring path control frame is allocated to the payload. A monitoring path control frame comprises a control type, an originating device address, a destination device address, and changed destination area address. The control type stores control contents of a definition, an instruction, and a response.

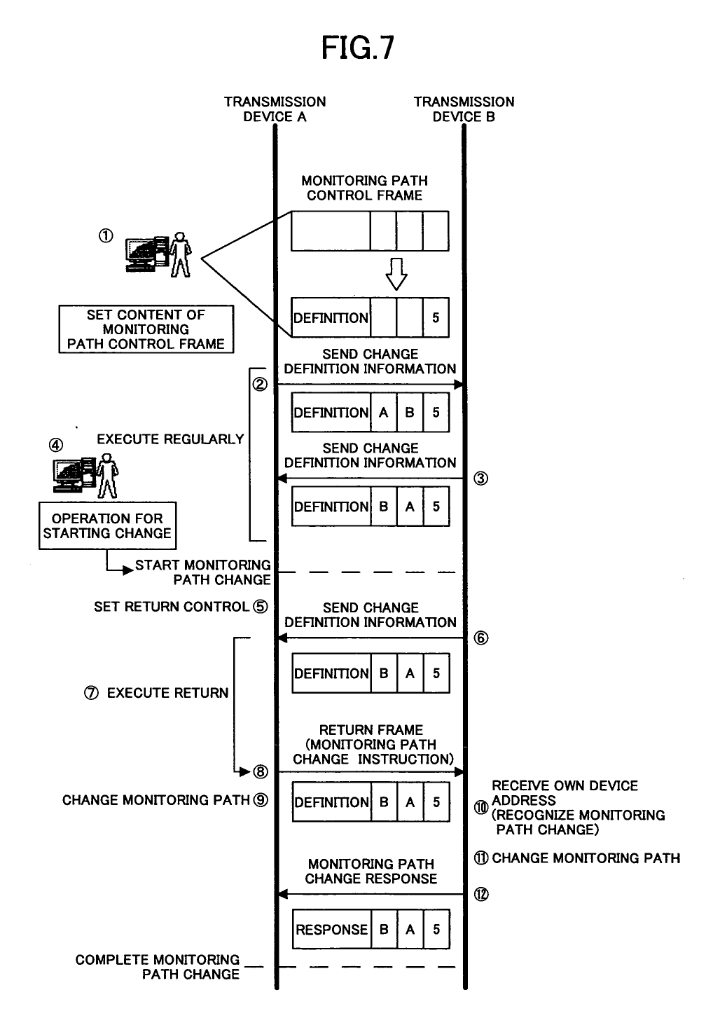

A first embodiment of a method of the present invention using the network shown in FIG. 5 is described with reference to a sequence diagram of FIG. 7. Circled numbers in FIG. 7 indicate step numbers. The monitoring path change in this embodiment is to switch a monitoring path area address from 1 to 5.

In step S1, contents of the monitoring path control frame are set with use of a front control panel of the monitoring terminal 52 or the transmission device A. In this example, the control type is set to “definition”, and the monitoring path area address is set to “5”.

In steps S2 and S3, the monitoring path control frame having the change definition information is transmitted/received regularly during the operation.

Specifically, in step S2, the transmission device A transmits a monitoring path control frame having “definition” for the control type, “A” for the originating device address, “B” for the destination device address, and “5” for the changed destination area address.

In step S3, the transmission device B transmits a monitoring path control frame having “definition” for the control type, “B” for the originating device address, “A” for the destination device address, and “5” for the changed destination area address.

In step S4, the execution of the monitoring path change is ordered with use of the front control panel of the monitoring terminal 52 or the transmission device A. In step S5, the transmission device A is set to execute the return control upon reception of the monitoring path control frame.

In step S6, as in step S3, the transmission device B transmits the monitoring path control frame having the change definition information. The transmission device A executes the return control set in step S5 over the received monitoring path control frame having the change definition information (step S7), and sends back the frame to the transmission device B (step S8). This operation corresponds to a monitoring path change instruction to the transmission device B.

In step S9, the transmission device A executes the monitoring path change to switch the monitoring path area address from 1 to 5, and stops the return control.

In step S10, the transmission device B recognizes the reception of the monitoring path change instruction since the originating device address in the monitoring path control frame is B, or, its own address. In step S11, the transmission device B executes the monitoring path change to switch the monitoring path area address from 1 to 5. In step S12, the transmission device B sets “response” to the control type to inform the completion of the monitoring path change. With the above sequence, the monitoring path change is completed.

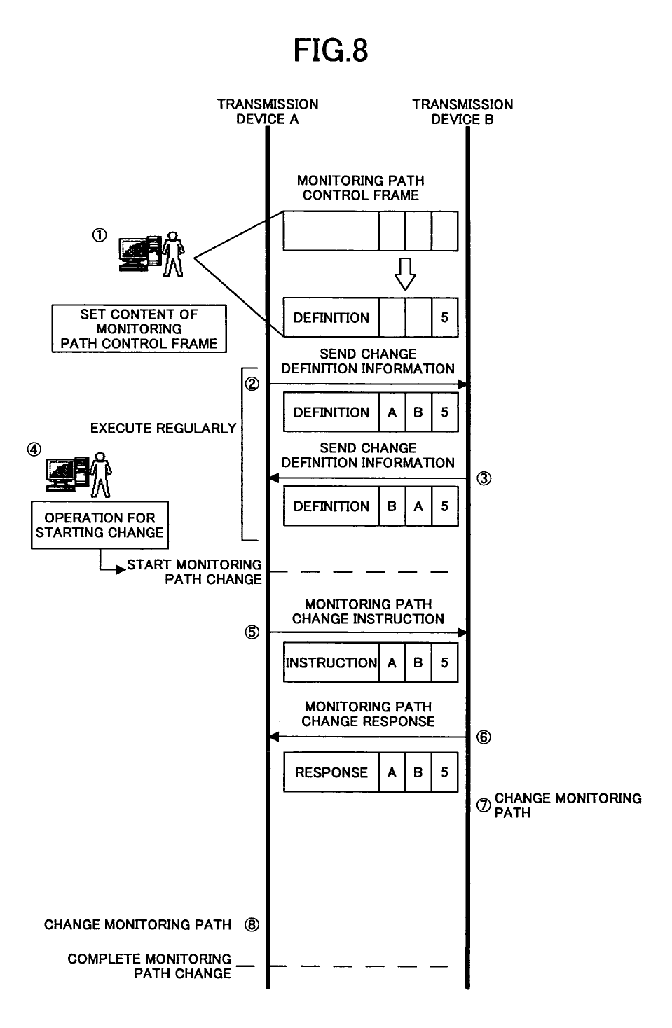

A second embodiment of the method of the present invention using the network shown in FIG. 5 is described with reference to a sequence diagram of FIG. 8. Circled numbers in FIG. 8 indicate step numbers. The monitoring path change in this embodiment is to switch a monitoring path area address from 1 to 5.

In step S1, contents of the monitoring path control frame are set with use of the front control panel of the monitoring terminal 52 or the transmission device A. In this example, the control type is set to “definition”, and the monitoring path area address is set to “5”.

In steps S2 and S3, the monitoring path control frame having the change definition information is transmitted/received regularly during the operation.

Specifically, in step S2, the transmission device A transmits a monitoring path control frame having “definition” for the control type, “A” for the originating device address, “B” for the destination device address, and “5” for the changed destination area address.

In step S3, the transmission device B transmits a monitoring path control frame having “definition” for the control type, “B” for the originating device address, “A” for the destination device address, and “5” for the changed destination area address.

In step S4, the execution of the monitoring path change is ordered with use of the front control panel of the monitoring terminal 52 or the transmission device A. In step S5, the transmission device A sets “instruction” to the control type so as to instruct the transmission device B to change the monitoring path.

In step S6, the transmission device B sets “response” to the control type to report the receipt of the instruction of the monitoring path change.

In step S7, the transmission device B executes the monitoring path change to switch the monitoring path area address from 1 to 5.

On receiving the monitoring path control frame having the “response” for the control type from the transmission device B, the transmission device A executes the monitoring path change to switch the monitoring path area address from 1 to 5 (step S8). With the above sequence, the monitoring path change is completed.

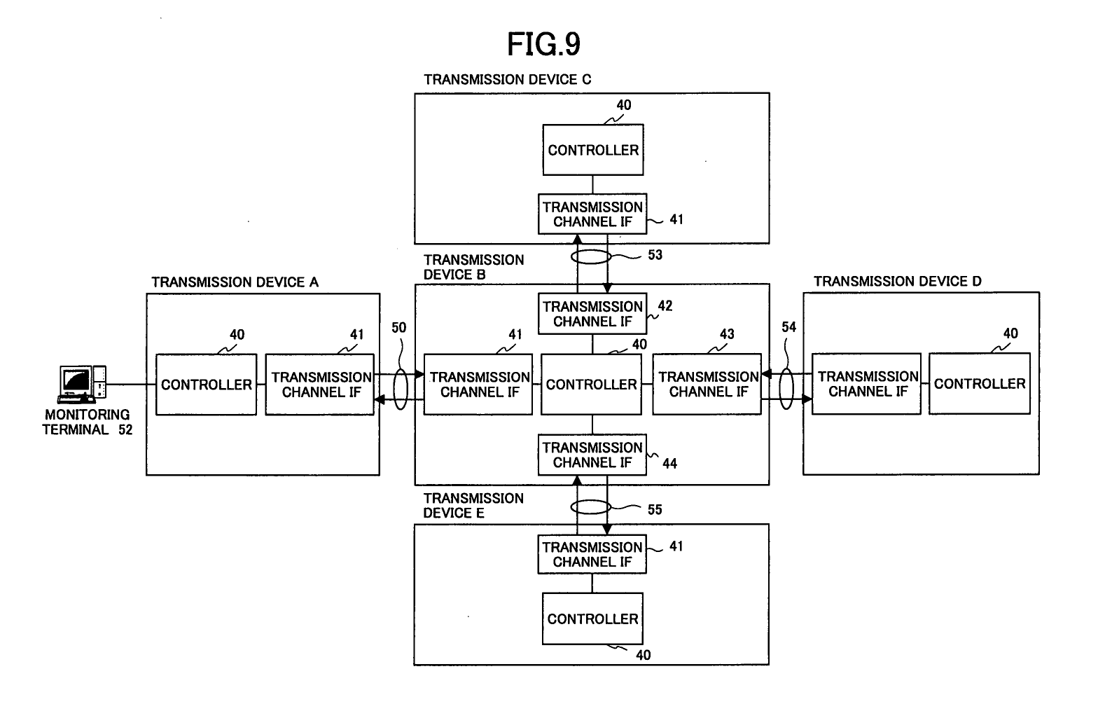

FIG. 9 shows a block diagram of a second embodiment of the network system, wherein elements identical to those in FIG. 5 bear the same reference numerals. In FIG. 9, a transmission device A has a controller 40 (corresponding to the monitoring path controller 20) and a transmission channel IF 41 (corresponding to the transmission channel IF 24). A transmission device B has a controller 40 and transmission channel IFs 41, 42, 43 and 44. The transmission channel IFs 41 of the transmission devices A and B are connected to each other by a transmission channel 50. The controller 40 of the transmission device A is connected to a monitoring terminal 52, which executes settings of the monitoring path change.

The transmission channel IF 42 of the transmission device B is connected to a transmission channel IF 41 of a transmission device C via a transmission channel 53. The transmission channel IF 43 of the transmission device B is connected to a transmission channel IF 41 of a transmission device D via a transmission channel 54. The transmission channel IF 44 of the transmission device B is connected to a transmission channel IF 41 of a transmission device E via a transmission channel 55.

In this network, the monitoring terminal 52 instructs the transmission device A to change a monitoring path. Then, the transmission device A instructs the transmission device B to change a monitoring path. The transmission device B instructs the transmission devices C, D and E to change monitoring paths. As such, all the transmission devices sequentially change the monitoring paths.

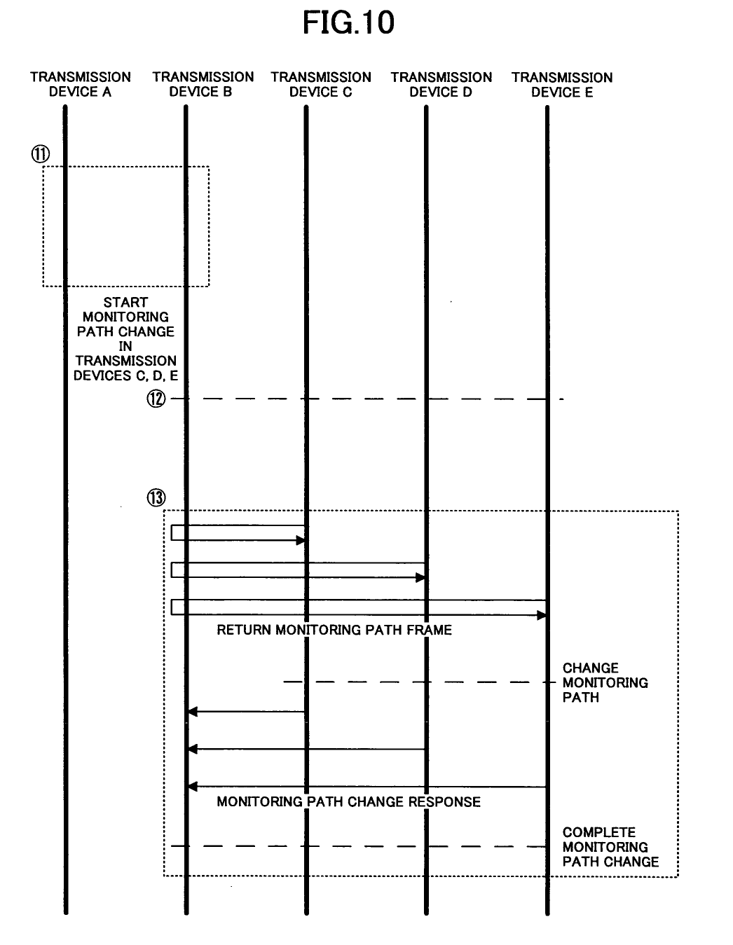

A third embodiment of the method of the present invention using the network shown in FIG. 9 is described with reference to a sequence diagram of FIG. 10. Circled numbers in FIG. 10 indicate step numbers.

In step S11, steps S1 through S12 in FIG. 7 are executed to complete the monitoring path change between the transmission devices A and B.

In step S12, the controller 40 of the transmission device B, triggered by the completion of the monitoring path change, searches for the transmission channels 53, 54 and 55 for which the change is not yet executed. The controller 40 of the transmission device B recognizes that the changes between the transmission devices B and C, B and D, and B and E are not yet executed, and starts the monitoring path change.

In step S13, the monitoring path changes between the transmission devices B and C, B and D, and B and E are executed. That is, the transmission device B is set to execute the return control upon reception of a monitoring path control frame. Each of the transmission devices C, D and E transmits a monitoring path control frames having change definition information. The transmission device B executes the return control over the received monitoring path control frame having the change definition information, and sends back the corresponding frame to the transmission devices C, D and E. This operation corresponds to a monitoring path change instruction to the transmission devices C, D and E. The transmission device B executes the monitoring path change to switch the monitoring path area address, and stops the return control.

Each of the transmission devices C, D and E recognizes the reception of the monitoring path change instruction since the originating device address in the corresponding monitoring path control frame is own address, and executes monitoring path change to change the monitoring path area address. Then, each of the transmission devices C, D and E sets “response” to the control type to report the completion of the monitoring path change. These steps correspond to steps S5 through S12 of FIG. 7. The monitoring path change is sequentially executed among plural transmission devices as described above, and thus the monitoring path change in all the devices in the network is completed.

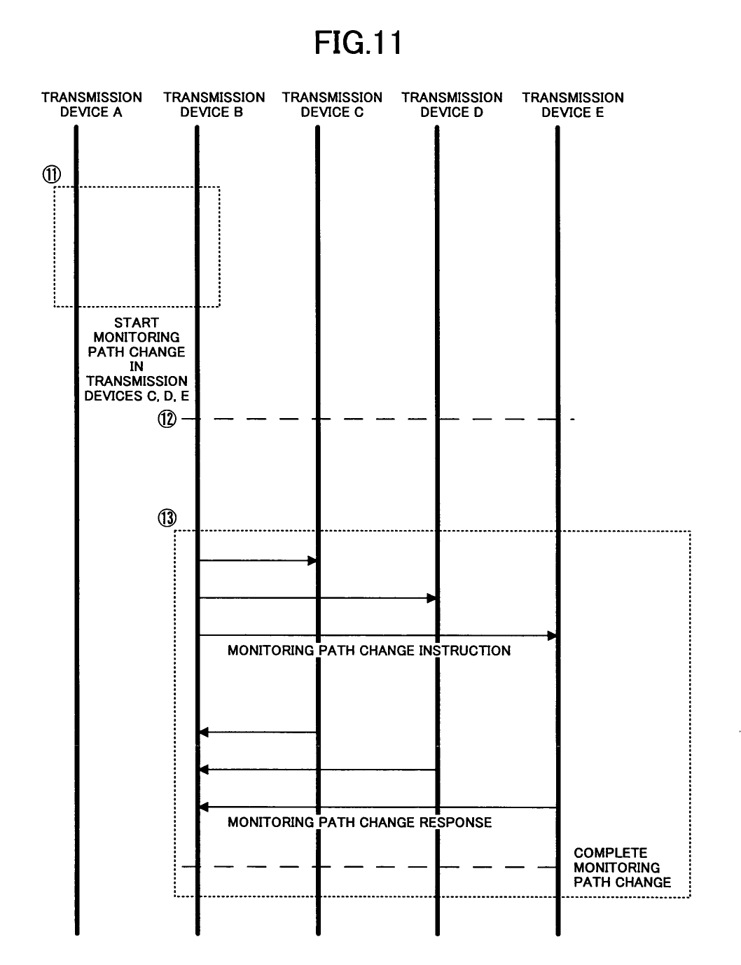

A fourth embodiment of the method of the present invention using the network shown in FIG. 9 is described with reference to a sequence diagram of FIG. 11. Circled numbers in FIG. 11 indicate step numbers.

In step S11, steps S1 through S8 in FIG. 8 are executed to complete the monitoring path change between the transmission devices A and B.

In step S12, the controller 40 of the transmission device B, triggered by the completion of the monitoring path change, searches for the transmission channels 53, 54 and 55 for which the change is not yet executed. The controller 40 of the transmission device B recognizes that the changes between the transmission devices B and C, B and D, and B and E are not yet executed, and starts the monitoring path change.

In step S13, the monitoring path changes between the transmission devices B and C, B and D, and B and E are executed. That is, the transmission device B sets “instruction” to the control type to instruct each of transmission devices C, D and E to change the monitoring path. Each of the transmission devices C, D and E sets “response” to the control type to report the receipt of the instruction of the monitoring path change.

Then, the transmission devices C, D and E respectively execute the monitoring path change to switch the monitoring path area address. On receiving the corresponding monitoring path control frames having the “response” for the control type from the transmission devices C, D and E, the transmission device B executes the monitoring path change to change the monitoring path area address. The monitoring path change is sequentially executed among plural transmission devices as described above, and thus the monitoring path change in all the devices in the network is completed.

According to this method, in the case where a network configuration or a line is changed, it is only needed to give an instruction for changing the monitoring path allocation area to one transmission device instead of to all the transmission devices. Other transmission devices then automatically sequentially execute the change. Therefore, compared to a method of broadcasting change instructions to all the devices or a method of individually changing the path in each device, the change is performed quickly and securely.

It should be understood that the monitoring path transmission manager 28 corresponds to a monitoring path transmission managing part in the following claims; the monitoring path reception manager 30 corresponds to a monitoring path transmission managing part; and the monitoring path controller 20 corresponds to a monitoring path control part.

1. A monitoring path changing method for changing monitoring paths by sending and receiving monitoring path control information in a system having a monitoring control terminal to control and monitor a plurality of transmission devices with use of the monitoring paths,
each of the monitoring paths corresponding to an area within a transmission channel data frame,
the monitoring path control information controlling the monitoring paths,
the monitoring control terminal being connected to one of the transmission devices,
the transmission devices being connected to each other via transmission channels so as to form a network,
the method comprising:
causing one of the transmission devices opposed by another of the transmission devices via one of the transmission channels to return monitoring path control information sent from the opposing transmission device; and
causing the opposing transmission device to execute a monitoring path change when the opposing transmission device receives the monitoring path control information sent by itself.

2. A monitoring path changing method for changing monitoring paths by sending and receiving monitoring path control information in a system having a monitoring control terminal to control and monitor a plurality of transmission devices with use of the monitoring paths,
each of the monitoring paths corresponding to an area within a transmission channel data frame,
the monitoring path control information controlling the monitoring paths,
the monitoring control terminal being connected to one of the transmission devices,
the transmission devices being connected to each other via transmission channels so as to form a network,
the method comprising:
causing one of the transmission devices opposed by another of the transmission devices via one of the transmission channels to instruct the opposing transmission device to execute a monitoring path change; and
causing the opposing transmission device to send a monitoring path change response to said one of the transmission devices and execute the monitoring path change.

3. The monitoring path changing method as claimed in claim 1,
wherein the transmission device that has executed the monitoring path change returns monitoring path control information sent from one or more transmission devices opposing thereto via the transmission channels that have not executed monitoring path changes, and
the opposing transmission devices that have not executed the monitoring path changes execute the monitoring path changes upon receiving the monitoring path control information sent by themselves.

4. The monitoring path changing method as claimed in claim 2,
wherein the transmission device that has executed the monitoring path change instructs one or more transmission devices opposing thereto via the transmission channels that have not executed monitoring path changes to execute the monitoring path changes, and
the opposing transmission devices that have not executed the monitoring path send monitoring path change responses to the transmission device that has executed the monitoring path change and execute the monitoring path changes.

5. A transmission device for changing monitoring paths by sending and receiving monitoring path control information in a system having a monitoring control terminal to control and monitor a plurality of transmission devices with use of the monitoring paths,
each of the monitoring paths corresponding to an area within a transmission channel data frame,
the monitoring path control information controlling the monitoring paths,
the monitoring control terminal being connected to one of the transmission devices,
the transmission devices being connected to each other via transmission channels so as to form a network,
the transmission device comprising:
a monitoring path transmission managing part to insert monitoring path control information into a monitoring path to send the monitoring path;
a monitoring path reception managing part to receive a monitoring path and extract monitoring path control information therefrom; and
a monitoring path control part to return the monitoring path control information received from another transmission device opposing via one of the transmission channels, and to execute a monitoring path change if the monitoring path control information returned from the opposing transmission device is the monitoring information sent by itself.

6. A transmission device for changing monitoring paths by sending and receiving monitoring path control information in a system having a monitoring control terminal to control and monitor a plurality of transmission devices with use of the monitoring paths,
each of the monitoring paths corresponding to an area within a transmission channel data frame,
the monitoring path control information controlling the monitoring paths,
the monitoring control terminal being connected to one of the transmission devices,
the transmission devices being connected to each other via transmission channels so as to form a network,
the transmission device comprising:
a monitoring path transmission managing part to insert monitoring path control information into a monitoring path to send the monitoring path;
a monitoring path reception managing part to receive a monitoring path and extract monitoring path control information therefrom; and
a monitoring path control part to instruct another transmission device opposing via one of the transmission channels to execute a monitoring path change, and then execute a monitoring path change upon receiving a monitoring path change response from the opposing transmission device.

7. The transmission device as claimed in claim 5, wherein, after the monitoring path control information sent by itself is returned from the transmission device opposing via one of the transmission channels and the monitoring path change is executed, the monitoring path control part returns monitoring path control information sent by one or more transmission devices opposing thereto via the transmission channels that have not executed monitoring path changes.

8. The transmission device as claimed in claim 6, wherein, after the monitoring path control information sent by itself is returned from the transmission device opposing via one of the transmission channels and the monitoring path change is executed, the monitoring path control part instructs one or more transmission devices opposing thereto via the transmission channels that have not executed monitoring path changes to execute monitoring path change.
